(19) United States
(12) Patent Application Publication
(10) Pub. No.: US 2013/0304730 A1
(43) Pub. Date: Nov. 14, 2013

(54) AUTOMATED ANSWERS TO ONLINE QUESTIONS

(71) Applicant: Xin Zhou, Beijing (CN)

(72) Inventor: Xin Zhou, Beijing (CN)

(73) Assignee: Google Inc., Mountain View, CA (US)

(21) Appl. No.: 13/980,242

(22) PCT Filed: Jan. 18, 2011
(86) PCT No.: PCT/CN2011/070363

§ 371 Date: Jul. 17, 2013

(51) Int. Cl. G06F 17/30

(52) U.S. Cl. CPC G06F 17/30979
USPC 707/723

(57) ABSTRACT

Methods, systems, and apparatus for providing automated answers to a question. In an aspect, a method include receiving a question from a client and querying a first repository for answers corresponding to the question. If no result is returned from the first repository, the method will parse the question into a set of keywords and query a second repository for answers corresponding to the set of keywords, and order the answers returned from the first repository or the second repository according to a ranking criteria, and finally present at least a subset of the ordered answers to the client.

### BACKGROUND

This disclosure relates to automatically providing answers to questions provided over a network, and in particular to providing answers to a question from existing answers provided over the network.

Live chatting and bulletin board system (BBS) posting on the Internet have become widespread in the Internet. Many users use chatting tools or online bulletin boards as a way of socializing with other users and communicating information. Information can be exchanged between different users of these online tools rapidly. Additionally, search engines also help people find information they want by providing search results that reference resources available on the Web.

Despite these many different tools and formats, users still may not receive answers to their questions, or may not receive the answers in a timely manner. For example, for a particular question, a user may post the question in an online chat room and wait to see if any other people in the chat room provide an answer to this question. The user may also post the question to a bulletin board and come back hours or days later to see if anybody has posted an answer to the question. Likewise, the user can also submit queries to a search engine, and review the search results and the web pages the search results reference in an attempt to glean any valuable information to the question. Similarly, the user may submit answers to specialized online platforms that ask users questions and provide answers to questions posted by others.

These platforms allow users to post questions and receive responses from a wide community of users of different backgrounds. However, if other users have not provided a similar question, the user typically does not receive an answer in a timely manner.

### SUMMARY

In general, one innovative aspect of the subject matter described in this specification relates to a method that provides automated answers to a question. The method may comprise receiving a question from a client and querying a first repository for answers corresponding to the question. If no result is returned from the first repository, the method will parse the question into a set of keywords and query a second repository for answers corresponding to the set of keywords. The method orders the answers returned from the first repository or the second repository according to a ranking criteria, and provides at least a subset of the ordered answers to the client. Alternatively, the step of parsing the question into a set of keywords and querying a second repository for answers corresponding to the set of keywords can happen concurrently with the step of querying the first repository.

In another aspect, the method may further include the step of normalizing the received question by at least one of: removing redundant words; correcting spelling mistakes; removing unnecessary punctuations; correcting incorrect punctuations; and removing redundant spaces.

Other embodiments of each of these aspects may include corresponding systems, apparatus, and computer programs recorded on computer storage devices, each configured to perform the actions of these methods.

The details of one or more embodiments are set forth in the accompanying drawings and the description below. Other features, objects and advantages will be apparent from the description and drawings, and from the claims.

### BRIEF DESCRIPTION OF THE DRAWINGS

FIG. 1 is a diagram of a system for providing automated answers to online questions.

FIG. 2 is a flow chart illustrating the creation and maintenance of data repositories for storing question answer pairs and keyword-set answer pairs.

FIGS. 3A-3B are exemplary repositories of question answer pairs and keyword-set answer pairs.

FIG. 4 is a flow chart illustrating a process of providing answers to an online question.

Like reference symbols in the various drawings indicate like elements.

### DETAILED DESCRIPTION

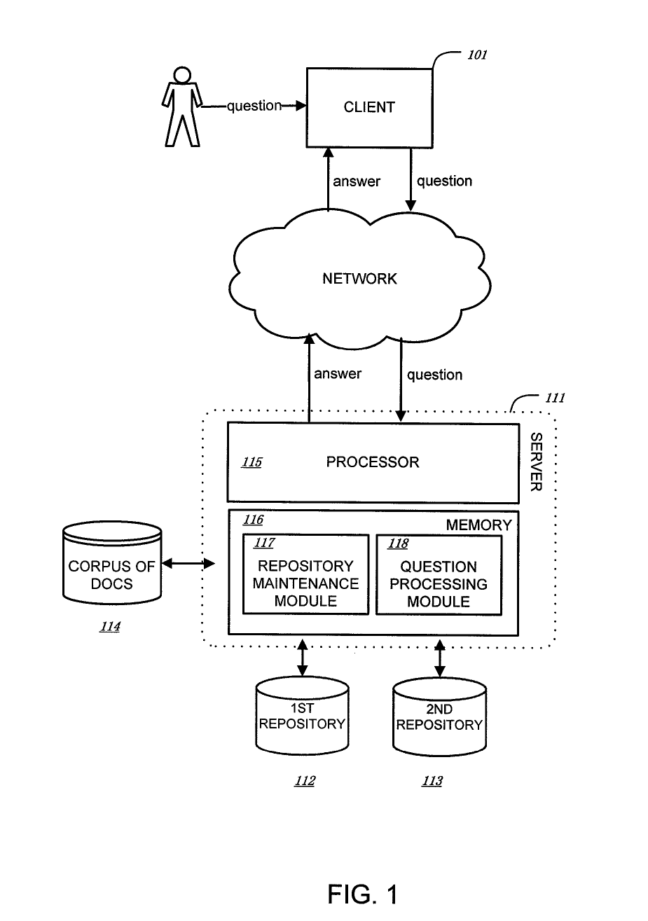

FIG. 1 is a diagram of a system for providing automated answers to online questions. In this system, the client 101 can be a desktop application or a web browser rendering a web application for online chatting. The web browser or desktop application receives input from a logged-in user and communicates the input as a message to another user or broadcasts the message to a group of users logged into the same service. The client can also be a bulletin board application that offers the user asynchronous interaction with other users. Alternatively, the client 101 can also be a web portal interface accepting questions from users and providing answers to the question.

A server 111 is located at another network location and handles requests from client 101 by its processor 115. A corpus of documents 114, a first repository 112 and second repository 113 are in data communication with the server 111. The corpus of documents 114 is a collection of documents crawled by a search engine over the Internet. The first repository 112 stores questions and their corresponding answers, while the second repository 113 is configured to store a set of keywords that are obtained from particular questions and the answers corresponding to the questions.

In some implementations, server 111 comprises a repository maintenance module 117 and a question processing module 118 in its memory 116. Requests relating to particular questions from client 101 are handled by the question processing module 118. The repository maintenance module 117 maintains and updates data in the first repository 112 and the second repository 113 by extracting question and answer data from the corpus of documents 114.

In an alternative implementation, the repository maintenance module 117 can be deployed on a server that is independent of the server 111. The repository maintenance module 117 on this independent server communicates with the first repository 113 and the second repository 114 and updates data in both repositories periodically or constantly using new question and answer data obtained from the corpus of documents 114.

Alternatively, the first repository 112 and the second repository 113, and the corpus of documents 114, can be located at different network locations and communicate with the server hosting the repository maintenance module 117 via a network, such as LAN, or the Internet, for example.

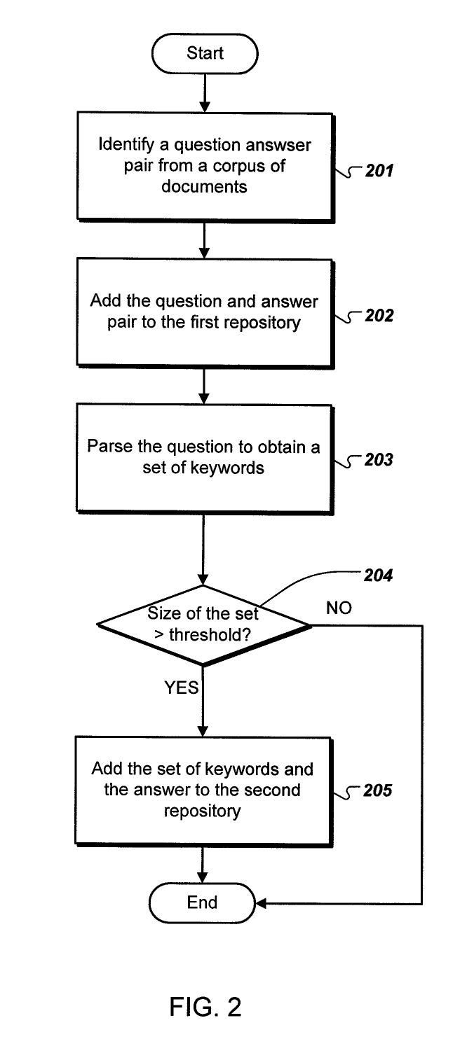

FIG. 2 is a flow chart illustrating the creation and maintenance of data repositories for storing question answer pairs and keyword-set answer pairs. A repository maintenance module 117, e.g., a program running for maintaining data of question answer pairs and keyword-set pairs in two repositories, is responsible for identifying a question-answer pair from a corpus of documents 114. The corpus of documents can include available log files of chat room messages, contents of web pages, etc., that have been crawled by a search engine and stored in an indexed database. As used herein, the term “chat room log files” includes chat room transcripts, web pages on which the transcripts are stored, and other files and storage schemes in which that data provided over a chat session are stored. The corpus of documents 114 can also be a data store that receives content submitted by various users. The repository maintenance module 117 may constantly or periodically query the corpus of documents 114 for any newly added data and analyze these data to identify questions submitted by users and their possible answers.

In some implementations, personal identifying information of users is removed for processing answers so that questions and corresponding answers are not linked to the users. For example, questions and answers may be anonymized in one or more ways before they are stored or used, so that personally identifiable information is removed. Likewise, a user's identity may be anonymized so that no personally identifiable information can be determined for the user and so that any identifiable information for user questions or answers are generalized (for example, generalized based on user demographics) rather than associated with the particular user. A user's geographic location may be generalized where location information is obtained (such as to a city, postal code, or state/province level), so that a particular location of a user cannot be determined.

The following example illustrates the creation and maintenance of data repositories. Assume a user has input a question “where is world exposition 2010 held?” in an online chat room and somebody else has given an answer “Shanghai”, and the content of the entire conversation have been crawled by a search engine. The repository maintenance module 117 may identify the question and answers by using one or more textual analysis routines and/or language analysis routines. For example, the repository maintenance module 117 may identify the question by recognizing the question mark “?” or the keyword “where”, and determining, for example, the immediate message following this question from another user as an answer to the question. The repository maintenance module 117 may also use field classifications, such as “Q” and “A” classifiers, e.g., “Q: where is world exposition 2010 held?” and “A: Shanghai.”

In some implementations, the question answer pairs may further be crawled from existing web documents. A web document may include such distinctive keywords as “question” and “answer”, or simpler classifiers, such as the letters “Q” and “A”. In one example, the repository maintenance module 117 parses web documents for potential question answer pairs. Upon identifying the existence of a keyword “question” immediately followed by colon, it may determine that the text following this keyword is actually a question. It stores the text following the colon until the first appearance of a question mark or a full stop, e.g., a period, etc., as a potential question.

The repository maintenance module 117 further parses the document to identify the next first appearance of a text string “answer:”, reads the text after this string until the first full stop, and store this text as the answer to the question. In some implementations, the distance between the end of the question until the beginning of the answer is calculated. If this distance is found to be beyond a threshold value, such as 50 or 100 characters, or if the string “answer:” is never identified, the module 117 will discard the question previously read as invalid and proceed to parse the remaining text in the web document for a possible pair of the strings “question:” and “answer:”.

In some implementations, in order to keep the identified questions and answers relatively short and brief, the lengths of the identified question and the its corresponding answer are limited to a maximum length. For example, if the question contains more than 50 characters (or words), or if the answer contains more than 30 characters (or words), the pair of question and answer will be discarded.

In a further implementation, in order to record the different answers to a particular question and their respective ranking, the extracted answers may be stored in a structure of the following form:

```
struct value {
  string answer;
  int count;
}
```

wherein the parameter “answer” stores the text of an answer, and the parameter “count” shows the number of times the value “answer” has been identified by the repository maintenance module 117. The count can be treated as the ranking or score for this particular answer to the question. In some implementations, the text of two answers that are determined to be similar can be represented by one of the strings. For example, the hyphens can be ignored, numeric spellings and numerals can be considered the same, etc.

Various other techniques may be employed to identify a question and its corresponding answer.

The question and answer identified from the corpus of documents using a particular technique, such as that described above, can be a question and answer pair improperly identified. An improperly identified question and answer pair are text that do not meet one or more predefined criteria or confidence threshold. Various techniques may be employed to identify and exclude improper question answer pairs from the repositories. For example, questions or answers that include spam terms, that cannot be parsed, appear to be random words or characters, etc., can be excluded. Additionally, a pair having a low score below a threshold over a predetermined period can also be considered an improper answer pair, as the answer may be inaccurate. The system can tolerate improper or inaccurate question and answer information in the first repository 112 or the second repository 113 by using these example error processing techniques.

In some implementations, the recognized question and answer may further be subject to a normalization process for normalization before being stored in the two repositories. Such normalization includes removing redundant words from the sentence of the question or answer; correcting any spelling mistakes; removing unnecessary punctuation; correcting incorrect punctuation; removing redundant spaces, etc. For example, the original question as obtained may be “where is world exxposition 2010 held?”, wherein “exxposition” has a spelling mistake and a redundant space exists between “2010” and “held”. The normalization process may identify such typing mistakes in the question and automatically correct the question into the normal form of “where is world exposition 2010 held?”

Similarly, such apparent typing mistakes may be removed from the answer corresponding to the question using the above normalization process. The corrected answer is thus more likely to be mapped to an existing question and answer pair in the repository.

Additionally, when the repository maintenance module 117 maps a new question and answer pair to an existing question and answer pair, the repository maintenance module 117 increases a score for the existing pair in the repository. The score is indicative of a confidence or quality of the question and answer pair, and the increase in the score indicates an increase in the confidence or quality (e.g., an increase in an accuracy of the question and answer pair).

For example, after the question answer pair has been identified, the repository maintenance module 117 may add the pair to the first repository 112 at step 202. The repository maintenance module 117 first determines whether the question answer pair already exists in the first repository 112 by querying the repository for an entry that has the question and answer. The determination of whether the question answer pair already exists in the first repository 112 can be made by an exact match of the text (or an exact match of the normalized text). If such a pair is determined to exist in the first repository 112, the adding process is accomplished by incrementing the score for this entry by 1 (or some other incremental value, depending on the scoring scheme that is used) in the first repository 112. If it is found that no such entry exists in the first repository 112 (e.g., there is not a match of the newly identified pair to an existing pair in the repository 112), a new entry for this question and answer pair is added to the repository and an initial score (e.g., a unit value or a minimum value for the particular scoring scheme used) is stored for this entry.

Other scoring techniques can also be used. For example, the score of the question answer pair in the first repository can be a weighted score based on some other parameters, such as the popularity of the source from which the question answer pair is extracted. A question answer pair extracted from a popular knowledge base can be given a higher score than those extracted from less popular knowledge bases. For example, the score of the question answer pair is an aggregate score influenced at least by the frequency of the same question answer pair being included into the first repository 112 and the popularity of the various sources of the same question answer pair, therefore reflecting the popularity of the question answer pair itself in the first repository 112.

After the step of adding the question answer pair to the first repository 112, the question will be parsed to obtain a set of keywords at step 203 before being added into the second repository 113. In some implementations, the step of parsing the question includes segmenting the question into a set of words using a language model corresponding to the language in which the question is written. For example, for the question of “ [symbol] ?” (Is potato fattening or not?), the question will be identified as being written in Chinese and is further processed using a Chinese language model to obtain the sentence structure of the question, thereby segmenting the question into a set of words including a subject, a verb, a predicate portion, a conjunction word, etc.

In some implementations, segmenting the question into a linguistic structure (e.g., words, phrases, etc.) can be further assisted by using a collection of search terms of a particular search engine, thereby identifying any new words or phrases that have become popular recently but not possible to be identified simply by a linguistic or semantic analysis of the question. In the above example, the term “ [symbol] ” may not be correctly recognized as a recognized word in a particular lexicon but may be identified by comparing this word with a collection of search terms. This collection of search terms can be maintained by a search engine for which some of the search terms are newly coined words.

Further, some stop words that appear most commonly in that language and do not provide specific information about the nature of the question can be removed from the list of words thus obtained. The remaining words therefore form a set of keywords to be added to the second repository 113.

In some implementations, the size of the set of keywords thus obtained may be determined and compared to a pre-determined threshold value before being added to the second repository 113. For example, if the size of the set is less than an ambiguity threshold (e.g., three words, four words, etc.), the set of keywords derived from the question and its corresponding answer is not added to the second repository 113, since the same set of keywords may be obtained by using the above process for another question that is linguistically different from this question. This reduces the likelihood of a possible inaccurate answer in the case in which a user inputs a question but gets an answer corresponding to a different question because the set of keywords as obtained from the input question is the same as the set of keywords of a different question stored in the second repository 113.

If the size of the set of keywords as obtained above is determined to be over the threshold value (step 204), the set of keywords of the question and the answer corresponding to the question are added to the second repository 113 (step 205). The particular steps of adding the keyword-set and answer pair to the second repository 113 is similar to those of adding the question and answer pair to the first repository as described above.

Keyword parsing can also be used to determine whether the question exists in the repository. In these implementations, the question is first parsed, and then the repository is search for an exact match or keyword match.

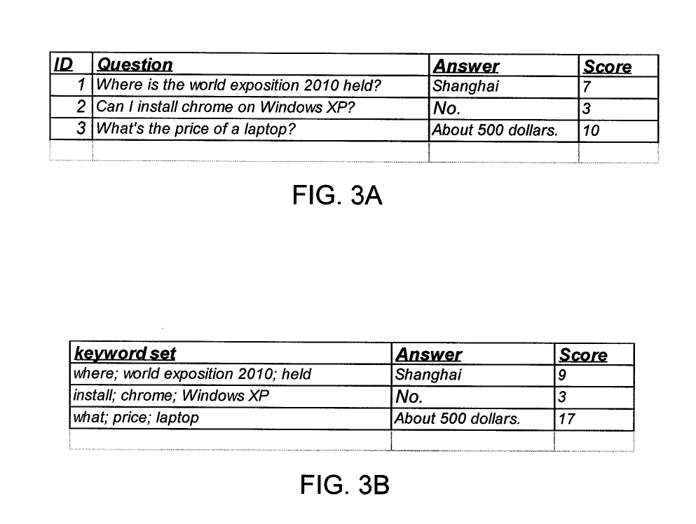

FIGS. 3A-3B are exemplary repositories of question answer pairs and keyword-set answer pairs added to the first repository 112 and the second repository 113. FIG. 3A is a table of example data in the first repository 112. In this table, the questions as strings of texts can be used as a whole when determining if another question is identical to one of these questions in this column, e.g., an exact match.

FIG. 3B is a table of example data in the second repository 113. In this table, the column “keyword set” includes a list of keywords in each entry. Different keywords are delimited by use of semicolons. The delimiter between the keywords can alternatively be a colon, a tabular space, or the like. In determining whether the set of keywords of an input question is identical to one of the sets of keywords stored in the second repository 113, each keyword in the set of keywords of the input question is compared with each keyword in an existing set of keywords in the repository to see there is an exact match for this keyword. In some implementations, the two sets of keywords will match only if both sets have exactly the same set of keywords, regardless of the sequence in which these keywords are listed. For example, consider the input question is “world exposition 2010, where is it held?” A set of keywords for this question may be “world exposition; where; held”, which will be determined as identical to the set “where; world exposition; held” derived from the question “where is the world exposition 2010 held?”

Other matching criteria can also be used, e.g., broad matching, in which a keyword may be substituted for another word (“shoes” for “sneakers”), phrase matching, etc.

Other attributes can also be maintained for each entry of the respective question answer pairs or the keyword-set answer pairs in both the first repository 112 and the second repository 113. These attributes can be the time of the most recent addition of a question answer pair or a keyword-set answer pair, the frequency of addition of a question answer pair or a keyword-set answer pair in the most recent past, for example in the past six months, etc. This information may be used for weighting the popularity of the question answer pair or the keyword-set answer pair when trying to obtain an answer for a question.

Alternative sequences can be performed for the above steps of adding the question answer pair and the keyword-set answer pair to the two repositories, respectively.

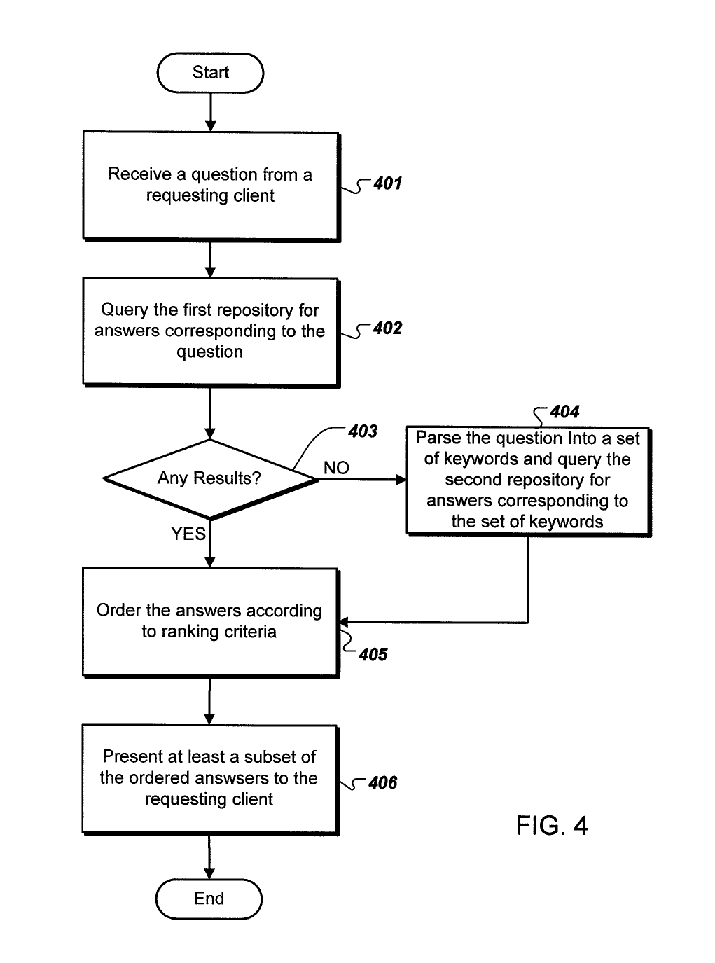

FIG. 4 is a flow chart illustrating a process of providing answers to an online question. At step 401, a question is received from a user (requestor) and submitted through a client, such as a chat application. In some implementations, a control is provided on the client for the user to submit a question to a particular server for a reply (answer) that is stored for a matching question in the repository. For example, when the user is chatting with a group of other users in a chat room and inputs the question “where is the exposition 2010 held?”, rather than sending this question to the group of users, the user can click on a control on his interface that sends this message to a server that implements the modules described above for processing. Alternatively the user can input the question into a text field on a web page and submit the question to the server through a web interface.

After the question is received at the server, the question processing module 118 may proceed to determine if the same question already exists in the first repository 112 at step 402. If one or more entries in the first repository 112 having the same question exist, the corresponding answers in each of these entries are retrieved for further processing. In some implementations, the question received from the client is further normalized before being used for querying the first repository 112. This normalization process may include removing redundant words from the sentence of the question, correcting any spelling mistakes; removing unnecessary punctuations; correcting incorrect punctuations; removing redundant spaces, etc, as specified above.

If no entry with a question identical to the received question can be found in the first repository 112 (e.g., no result for the question is returned), the question processing module 118 may parse the received question to obtain a set of keywords corresponding to this question (step 404). This parsing step can be similar to that described in step 203 in FIG. 2 (e.g., segmenting the answer into a set of words using a language model corresponding to the language in which the question is written, and optionally using search terms collected by a search engine), except that the size of the obtained set of keywords is compared to the ambiguity threshold. The set of keywords for the received question will be used as a key to query the second repository 113. If one or more entries having the same set of keywords in column “keywords” exist in the second repository 113, or otherwise match to a sufficient degree of confidence, their corresponding answers in column “answer” are retrieved and returned to the question processing module 118 (step 404).

At step 405, the answers for the received question, if any, retrieved from either the first repository 112 or the second repository 113, are ordered according to the respective scores of these answers. Alternatively, other information, such as the time of the most recent addition of a question answer pair or a keyword-set answer pair, the frequency of addition of a question answer pair or a keyword-set answer pair in the past six months, may be used in determining the ranking score for each of the answers in the result.

Finally, the ordered set of answers for the received question is sent at step 406 by the question processing module 118 to the client 101 where the question originates via a network, such as the Internet. In some implementations, only a required number of answers ranked highest are sent to the requesting client 101, in accordance with the parametric value received together with the question from the requesting client 101. For example, the requesting client 101 may only be requesting for one answer to the question submitted. In this case, the question processing module 118 will pick the highest-ranked answer and send it to the client 101.

In alternative implementations, the step of parsing the question into a set of keywords after receiving the question from the requesting client can be performed before querying the first repository 112 for any answers of the question at step 402. Alternatively, the parsing step and the step of querying the second repository 113 can be performed concurrently with the step of querying the first repository, in order to save the extra waiting time in processing the received question in querying both repositories sequentially.

In variations of this implementation, both repositories can be queried even if a match in the first repository is found. Answers from both repositories can thus be returned in this implementation, and results are returned from both for their respective queries. The concurrent execution of both processes can be accomplished by employing such programming technique as threads in multitasking.

Embodiments of the subject matter and the functional operations described in this specification may be implemented in digital electronic circuitry, in tangibly-embodied computer software or firmware, in hardware, including the structures disclosed in this specification and their structural equivalents, or in combinations of one or more of them. Embodiments of the subject matter described in this specification may be implemented as one or more computer programs, i.e., one or more modules of computer program instructions encoded on a computer storage medium for execution by, or to control the operation of, data processing apparatus. Alternatively or in addition, the program instructions may be encoded on a propagated signal that is an artificially generated signal, e.g., a machine-generated electrical, optical, or electromagnetic signal, that is generated to encode information for transmission to suitable receiver apparatus for execution by a data processing apparatus. The computer storage medium may be a machine-readable storage device, a machine-readable storage substrate, a random or serial access memory device, or a combination of one or more of them.

The term “data processing apparatus” encompasses all kinds of apparatus, devices, and machines for processing data, including by way of example a programmable processor, a computer, or multiple processors or computers. The apparatus may include special purpose logic circuitry, e.g., an FPGA (field programmable gate array) or an ASIC (application-specific integrated circuit). The apparatus may also include, in addition to hardware, code that creates an execution environment for the computer program in question, e.g., code that constitutes processor firmware, a protocol stack, a database management system, an operating system, or a combination of one or more of them.

A computer program (which may also be referred to as a program, software, software application, script, or code) may be written in any form of programming language, including compiled or interpreted languages, or declarative or procedural languages, and it may be deployed in any form, including as a stand-alone program or as a module, component, subroutine, or other unit suitable for use in a computing environment. A computer program may, but need not, correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer may be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, embodiments of the subject matter described in this specification may be implemented on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input. In addition, a computer may interact with a user by sending documents to and receiving documents from a device that is used by the user; for example, by sending web pages to a web browser on a user's client in response to requests received from the web browser.

While this specification contains many specific implementation details, these should not be construed as limitations on the scope of any inventions or of what may be claimed, but rather as descriptions of features that may be specific to particular embodiments of particular inventions. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

Particular embodiments of the subject matter have been described. Other embodiments are within the scope of the following claims. For example, the actions recited in the claims may be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method of providing automated answers to a question, comprising:
receiving data defining a question from a client, the question including a plurality of words;
querying a first repository for answers corresponding to the question, the first repository storing question answer pairs, each of the question answer pairs have a respective score corresponding to its popularity;
parsing the question into a set of keywords and querying a second repository for answers corresponding to the set of keywords, the second repository storing keyword-set answer pairs, each of the keyword-set answer pairs having a respective score corresponding to its popularity;
ordering the answers returned from the first repository or the second repository according to ranking criteria; and
providing at least a subset of the ordered answers to the client.

2. The method of claim 1, further comprising normalizing the received question by at least one of: removing redundant words; correcting spelling mistakes; removing unnecessary punctuation; correcting incorrect punctuation; and removing redundant spaces.

3. The method of claim 1, wherein parsing the question into set of keywords comprises:
segmenting the question into a set of words using a language model corresponding to the language in which the question is written; and
removing the stop words from the set of words.

4. The method of claim 3, wherein segmenting the question is refined by comparing at least part of the question against a collection of search terms.

5. The method of claim 1, wherein providing at least a subset of the ordered answers comprises providing the answer having the highest ranking to the client.

6. The method of claim 1, wherein the client comprises at least one of a chat room application, a bulletin board application, and a client side interface to a search engine.

7. The method of claim 1, wherein parsing the question into a set of keywords and querying a second repository for answers corresponding to the set of keywords occurs concurrently with querying the first repository.

8. The method of claim 1, wherein parsing the question into a set of keywords and querying a second repository for answers corresponding to the set of keywords occurs only when no answers are received in response to the querying of the first repository.

9. A system of providing automated answers to a question, comprising:
a first repository, storing question answer pairs, each of the question answer pairs having a respective score corresponding to its popularity;
a second repository, storing keyword-set answer pairs, each of the keyword-set answer pairs having a respective score corresponding to its popularity;
a question processing module configured to:
receive data defining a question from a client, the question including a plurality of words;
query the first repository for answers corresponding to the question;
parse the question into a set of keywords and query the second repository for answers corresponding to the set of keywords;
order the answers returned from the first repository or the second repository according to ranking criteria;
provide at least a subset of the ordered answers to the client for presentation.

10. The system of claim 9, wherein the question processing module is further configured to normalize the received question by at least one of: removing redundant words; correcting spelling mistakes; removing unnecessary punctuation; correcting incorrect punctuation; and removing redundant spaces.

11. The system of claim 9, wherein the step of parsing the question into a set of keywords comprises at least:
segmenting the question into a set of words using a language model corresponding to the language in which the question is written; and
removing the stop words from the set of words.

12. The system of claim 11, wherein segmenting the question is refined by comparing at least part of the question against a collection of search terms.

13. The system of claim 9, wherein the parsing the question into a set of keywords and querying a second repository for answers corresponding to the set of keywords occurs currently with the step of querying the first repository.

14. The system of claim 9, wherein parsing the question into a set of keywords and querying a second repository for answers corresponding to the set of keywords occurs only when no answers are received in response to the querying of the first repository.

15. The system of claim 9, further comprising a repository maintenance module for maintaining the first and second repositories, the repository maintenance module being configured to:
identify a question-answer pair from a document among a corpus of documents, wherein the answer is mapped to the question;
add the question-answer pair to the first repository;
parse the question in the question-answer pair to obtain a set of keywords; and
add the set of keywords and the answer to the second repository.

16. The system of claim 15, wherein the keywords and the answer are added to the second repository only if the size of the set of keywords is over a threshold.

17. The system of claim 16, wherein a distance between the end of the question and the beginning of the answer of the identified question-answer pair in the document is within a first predetermined threshold value.

18. The system of claim 16 or 17, wherein the length of the question in the identified question-answer pair is within a second predetermined threshold value, and the length of the answer of the identified question-answer pair is within a third threshold value.

19. The system of claim 15, wherein adding the question-answer pair to the first repository comprises:
determining whether the question-answer pair already exists in the first repository;
if the question-answer pair already exists in the first repository, increasing the ranking of the question-answer pair in the first repository, or if the question-answer pair does not exist in the first repository, storing a new entry for the question-answer pair in the first repository and initializing a ranking for the pair.

20. The system of claim 15, wherein adding the set of keywords and the answer to the second repository in the index system comprises:
determining whether a pair of the set of keywords and the answer already exists in the second repository;
if the pair of the set of keywords and the answer already exists in the second repository, increasing the ranking of the pair in the second repository; or
if the pair of the set of keywords and the answer does not exist in the second repository, storing a new entry for the pair of the set of keywords and the answer in the second repository and initializing a ranking for the pair.

21. The system of claim 15, wherein the corpus of documents comprises chat-room transcripts, bulletin board data, and web pages.

22. The system of claim 15, wherein the step of identifying a question-answer pair includes normalizing the question and answer in the pair by at least one of: removing redundant words; correcting spelling mistakes; removing unnecessary punctuation; correcting incorrect punctuation; removing redundant spaces.

23. A computer-implemented method, comprising:
identifying a question-answer pair from a document among a corpus of documents, wherein the answer is mapped to the question;
adding the question-answer pair to a first repository;
parsing the question in the question-answer pair to obtain a set of keywords;
associating the set of keywords with the answer; and
adding the set of keywords and the answer to a second repository.

24. The method of claim 23, wherein the keywords and the answer are added to the second repository only if the size of the set of keywords is over a threshold.

25. The method of claim 23, wherein identifying a question-answer pair from a document among a corpus of documents comprises identifying only the question-answer pair only if the distance between an end of the question and a beginning of the answer in the document is within a first predetermined threshold value.

26. The method of claim 25, wherein identifying a question-answer pair from a document among a corpus of documents comprises identifying a question only if a length of the questions is within a second predetermined threshold value, and identifying an answer only if a length of the answer of the identified question-answer pair is within a third threshold value.

27. The method of claim 23, wherein adding the question-answer pair to the first repository comprises:
determining whether the question-answer pair already exists in the first repository;
if the question-answer pair already exists in the first repository, increasing the ranking of the question-answer pair in the first repository; and
if the question-answer pair does not exist in the first repository, storing a new entry for the question-answer pair in the first repository and initializing a ranking for the pair.

28. The method of claim 23, wherein adding the set of keywords and the answer to the second repository in the index system comprises:
determining whether a pair of the set of keywords and the answer already exists in the second repository;
if a pair of the set of keywords and the answer already exists in the second repository, increasing the ranking of the pair in the second repository; and
if a pair of the set of keywords and the answer does not exist in the second repository, storing a new entry for the pair of the set of keywords and the answer in the second repository and initializing a ranking for the pair.

29. The method of claim 23, wherein the corpus of documents comprises chat-room messages, bulletin board messages, and web pages.
